(19) United States
(12) Patent Application Publication
(10) Pub. No.: US 2011/0156855 A1
(43) Pub. Date: Jun. 30, 2011

(54) FUSING DEVICE AND BATTERY ASSEMBLY COMPRISING THE SAME

(76) Inventors: Zhiwei Tong, Shenzhen (CN); Weixin Zheng, Shenzhen (CN); Jianhua Zhu, Shenzhen (CN)

(21) Appl. No.: 12/976,962

(22) Filed: Dec. 22, 2010

(30) Foreign Application Priority Data
Dec. 31, 2009 (CN) 200910238943.7

(51) Int. Cl. H01H 37/02

(52) U.S. Cl. 337/121

(57) ABSTRACT

A fusing device comprises a core portion, a first terminal, a second terminal, and at least a thermal expanding element provided between the first flange and the second flange with two ends thereof against the first and second flanges respectively, which is configured to break the core portion during thermal expanding. A battery assembly comprises a plurality of battery electrically connected in series, parallel or in series and parallel with the fusing device as described hereinabove.

### CROSS-REFERENCE TO RELATED APPLICATION

The present application claims priority to and benefits of Chinese Patent Application No. 200910238943.7, filed with the State Intellectual Property Office of the People's Republic of China (SIPO) on Dec. 31, 2009, the entire content of which is hereby incorporated by reference.

### FIELD

The disclosure relates to the protection of an electrical device, more particularly to a fusing device for protecting an electrical device, such as a circuit or battery pack, and a battery assembly comprising the same.

### BACKGROUND

Fusing devices are widely used in electric systems for short circuit protection, over current protection or over heat protection, for example. The common fusing device, such as a thermal cutoff or a fuse, may be blown out when a part of an electrical connection is overheated. For example, a metallic melt having a high melting point and a small conductive area is used as a fuse, which may be melted to break the connection at a certain large current.

Such fusing devices may have the shortcomings of a high internal resistance and a short response time which may cause unintentional fusing breaks. In addition, the fusing device may not withstand a pulse current with a low duty ratio but a large instantaneous current, which is common in an electric vehicle system. This may cause frequent system interruptions.

### SUMMARY

According to an aspect of the disclosure, a fusing device may comprise a core portion formed with a first flange at an end thereof and a second flange at the other end thereof; a first terminal electrically connected with one end of the core portion where the first flange is formed; a second terminal electrically connected with the other end of the core portion where the second flange is formed; and at least a thermal expanding element provided between the first flange and the second flange with two ends thereof against the first and second flanges respectively, which is configured to break the core portion during thermal expanding.

According to another aspect of the disclosure, a battery assembly comprising a plurality of batteries electrically connected in series, parallel or in series and parallel with the fusing device as described hereinabove is also provided.

According yest another aspect of the disclosure, a fusing device includes a core portion having a first section and a second section; and a thermal expanding element connected to the first and second sections of the core portion. The core portion and thermal expanding element are arranged such that an electric current passing through the core portion heats the thermal expanding element and causes the thermal expanding element to expand thermally. The thermal expansion of the thermal expanding element breaks the core portion when the temperature of the thermal expanding element exceeds a certain value. The thermal expanding element may be directly or indirectly connected to at least one of the first and second sections of the core portion

According a further aspect of the disclosure, a fusing device includes a core portion having a first section and a second section; and a thermal expanding element connected to the first and second sections of the core portion. The core portion and thermal expanding element are arranged such that an electric current passing through the core portion heats the thermal expanding element and causes the thermal expanding element to expand thermally. The thermal expansion of the thermal expanding element breaks the core portion when the current in the core portion exceeds a certain value. The thermal expanding element may be directly or indirectly connected to at least one of the first and second sections of the core portion

### BRIEF DESCRIPTION OF THE DRAWINGS

Exemplary embodiments of the present disclosure will be described in detail based on the following figures in which:

FIG. 1 is an exploded view of a fusing device according to an embodiment of the present disclosure;

FIG. 2 is a perspective view of a fusing device according to the embodiment shown in FIG. 1;

FIG. 3(a) is a front view of a fusing device according to the embodiment shown in FIG. 1;

FIG. 3(b) is a section view along a line A-A shown in FIG. 3(a);

FIG. 4(a) is a front view of a fusing device according to another embodiment of the present disclosure;

FIG. 4(b) is a section view along a line B-B shown in FIG. 4(a);

FIG. 5 is an enlarged view of part C shown in FIG. 4(b); and

FIG. 6 is a schematic view of a battery assembly comprising a fusing device according to an embodiment of the present disclosure.

### DETAILED DESCRIPTION

It will be appreciated by those of ordinary skill in the art that the disclosure may be embodied in other specific forms without departing from the spirit or essential character thereof. The presently disclosed embodiments are therefore considered in all respects to be illustrative and not restrictive.

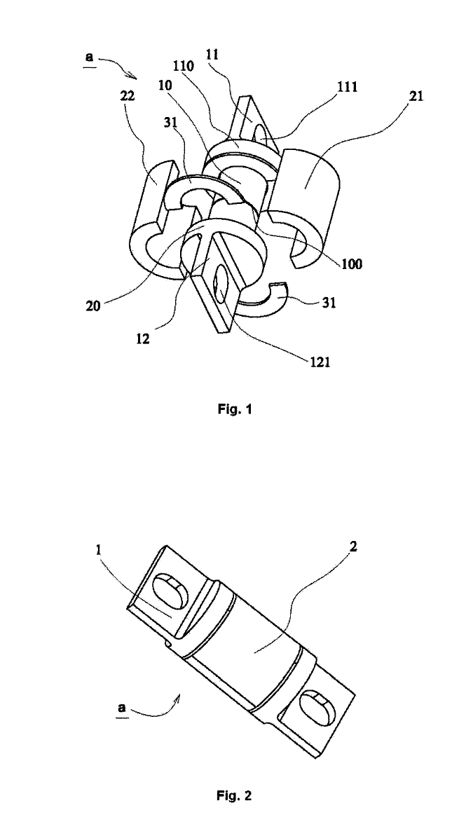

FIG. 1 is an exploded view of a fusing device according to an embodiment of the present disclosure, and FIG. 2 is a perspective view of a fusing device according to an embodiment of the present disclosure. As shown in FIGS. 1 and 2, the fusing device may comprise: a core portion 10 formed with a first flange 110 at an end of the core portion 10 and a second flange 120 at the other end of the core portion 10; a first terminal 11 electrically connected with the end of the core portion 10 where the first flange 110 is formed; a second terminal 12 electrically connected with the other end of the core portion 10 where the second flange 120 is formed; and at least a thermal expanding element 21, 22 provided between the first flange 110 and the second flange 120 with two ends of the thermal expanding element 21, 22 against the first and second flanges 110, 120 respectively. The thermal expanding element is configured to break the core portion 10 during a thermal expansion of the thermal expanding element.

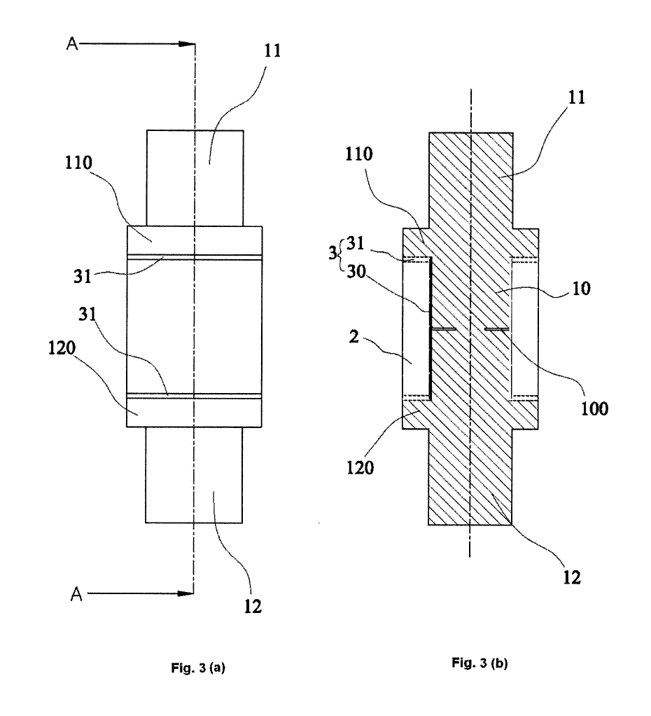

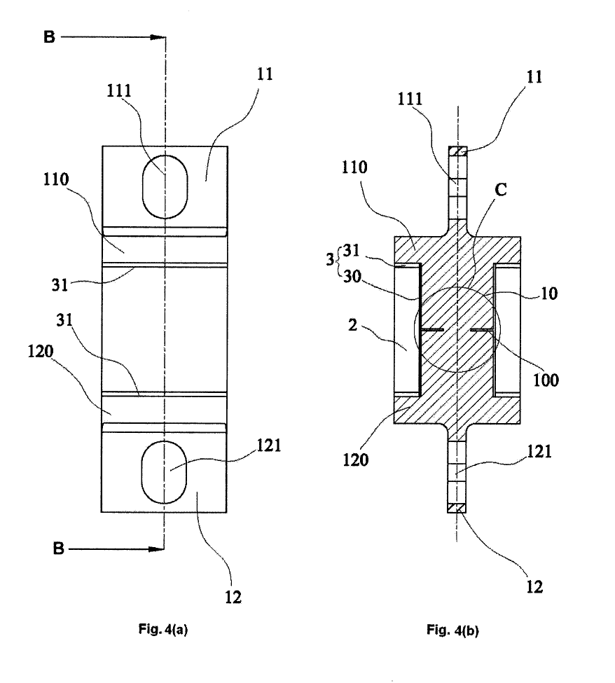

As shown in FIGS. 3(a)-4(b), the thermal expanding element 21, 22 includes two components 21, 22, which each have a semi-cylindrical shape, like a semi-shaped sheath, that is fitted over the core body 10.

The core portion 10 may have a rectangular, circular or triangular cross section. For example, as shown in FIGS. 1 and 2, the core portion 10 is a cylindrical body with a circular cross section. The core body 10 may be made from silver, copper, copper alloy, aluminum, or aluminum alloy. The conductivity and the cross section of the core body 10 may be designed according to the actual need of the over-current capacity.

As described above, the two components of the thermal expanding elements 21, 22 may be disposed between the first flange 110 and the second flange 120. The two ends of the thermal expanding element 21, 22 push against the first flange 110 and the second flange 120, respectively. The thermal expanding element 21, 22 may be made from a thermal expansion material such as a linear thermal expansion material, which may restore its original shape after the temperature of the material is higher than a transition temperature of the material. In one instance, the thermal expansion material may have an expansion ratio of about 8% to about 10%. And the expanding force is design to break the core portion 10 as designed. It should be noted that term “thermal expanding material” means any material which may restore its shape after its temperature reaches the transitional temperature of the material rather than limited by those only disclosed herein. In general, the thermal expanding material includes any material that, when heated to a predetermined temperature, breaks the core portion.

According to an embodiment of the present disclosure, the thermal expanding element 21, 22 between the first and second flanges 110, 120 is made from a thermal expansion material, which may expand and push the first and second flanges 110, 120 with an increasing force while heated by an electric current. When the strength of the core portion 10 is exceeded by the expanding force of the thermal expanding element 21, 22 generated between the first and the second flanges 110, 120, the core portion 10 may be fractured to break the electrical connection.

In some embodiments, the fusing device may further comprise a first insulating member 30 provided between the core portion 10 and the thermal expanding element 21, 22, which is electrically insulated and thermally conductive, and a pair of second insulating members 31 provided between the ends of the thermal expanding element 21, 22 and the first and second flanges 110, 120, respectively. It should be noted here that the first insulating member 30 and the second insulating members 31 are formed to enhance the thermal conduction between the core body 10 and the thermal expanding element 21, 22 without electrical conduction therebetween. Thus, any means or method for achieving the same is applicable in the present disclosure, which shall be included in the scope of the present disclosure.

As shown in FIG. 1, according to an embodiment of the present disclosure, the first insulating member 30 may be an insulating layer coated onto the core portion 10, or an injected portion between the thermal expanding elements 21, 22 and the core portion 10.

According to an embodiment of the present disclosure, at least one of the second insulating members 31 is a gasket or an insulating ring, or an insulating layer formed on the first or/and second flange(s) 110, 120. In one example, aluminum nitride or thermal conductive adhesion may be coated onto the external surfaces of the core portion 10 and the first and second flanges 110, 120.

According to another embodiment of the present disclosure, at least one of the second insulating members 31 may comprise a pair of semi-circular gaskets or insulating rings connected with each other between the first and second flanges 110, 120 and the thermal expanding element 21, 22. In addition, the thermal expanding element 21, 22 may be formed by integrally connect by welding, bonding, or fastening its two halves. The core body 10 may be sealed by the thermal expanding element 21, 22 and first insulating member 30, and it may endure the shock of the peak value of a pulse current, i.e. instantaneous over-current, and electric arcs that commonly occurred may be avoided in the fusing device according to the present disclosure.

In some embodiments, the thermal expansion material may be selected from a group consisting of a Cu-based shape-memory alloy, Fe-based shape-memory alloy, Ni-based shape-memory alloy, and shape-memory ceramic material. Obviously, when the thermal expansion material is selected from a metal or alloy, an insulating member is preferable whereas when the thermal expansion material is selected from a non-metallic material such as a ceramic material, an insulating member is not needed. It may be well understood by one skilled in the art that the core body 10 and the thermal expanding element 21, 22 may not be mutually electrical conductive in the present disclosure. According to an embodiment of the present disclosure, an insulation treatment between the core body 10 and the thermal expanding element 21, 22 may be performed when the thermal expanding element 21, 22 is made from a metal or alloy.

As shown in FIG. 5, the core portion 10 may have at least one notch 100. According to an embodiment of the present disclosure, the notch may be formed along a cross section preferably in the middle portion of the core portion 10, as shown in FIGS. 3(b) and 4(b), preferably with a depth of 1.5 mm to about 3 mm into the core portion 10 and a height of about 0.1 mm to about 0.5 mm in a longitudinal direction of the core portion 10.

The first and second terminals 11, 12 are the electrical connection terminals when the fusing device is connected into the circuit. In one instance, the first or second terminal 11, 12 may have a through hole for connecting. As shown in FIGS. 1, 2, 4(a) and 4(b), the through holes 111, 121 may be formed on the first terminal 11 and the second terminal 12 respectively.

Normally, the over-current response rate of the fusing device depends on the conductivity of the core body 10 and the transition temperature of the thermal expanding elements 21, 22. To increase the over-current response rate, the cross section of the core body 10 may be reduced to increase the rate of temperature rise, or the transition temperature of the thermal expanding element 21, 22 may be reduced to reduce the over-current response time. Conversely, to reduce the response rate or increase the over-current response time, the cross section of the core body 10 may be increased or the transition temperature of the thermal expanding element 21, 22 may be increased.

According to an embodiment of the present disclosure, the fusing device may have a designed over-current capacity of about 300A, the diameter of the core portion 10 may be about 6 mm to about 9 mm; the length of the core portion 10 may be about 15 mm to about 20 mm; the height of the notches along the longitudinal direction of the core body 10 may be about 0.1 mm to about 0.5 mm; the depth of the notches into the core body 10 may be about 1.5 mm to about 3 mm; the transition temperature of the thermal expanding element 21, 22 may be about 100° C. to about 130° C., the thermal expanding element 21, 22 may have an expansion rate of about 8%; and the expanding lengths of the thermal expanding elements 21, 22 may be about 1.2 to about 1.6 mm. When the electrical connection is cut off, the separated width of the notch 100 may be about 1.1 mm to about 1.5 mm when the fusing device ensures that there is no breakdown up to the voltage of 1000V.

The operation of the fusing device will be described briefly below. Normally, the core body 10 is heated by the current, and part of the heat is transferred to the thermal expansion material such as a shape-memory alloy, and the temperature of the shape-memory alloy is increased. Under normal condition, the temperature rise of the shape-memory alloy is lower than 30° C., and the total temperature is lower than the transition temperature of the shape-memory alloy. Thus the shape-memory alloy has no deformation. During a short-circuit, due to the large current, the temperatures of the core body 10 and the shape-memory alloy increase quickly, and the shape-memory alloy is deformed to fracture the core portion 10 when the temperature reaches up to and above the transition temperature whereas the length change of the shape-memory alloy is confined by the first flange 110 and the second flat portion 120. Because the material will restore its shape and length, a large restoring force will be generated between the first flange 110 and the second flange 120. And when the restoring or deforming force of the thermal expanding elements 21, 22 is large enough to overcome the yield limit of the core portion 10, the core portion 10 may be broken at the weakest region, i.e., the notches 100, and then the electrical connection between the first terminal 11 and the second terminal 12 is severed.

With the fusing device as described above, the internal resistance thereof and the over-current response time are optimal in addition to enhanced endurance to the shocks of a pulse current. Further, electric arcs are avoided in the fusing device of the present disclosure.

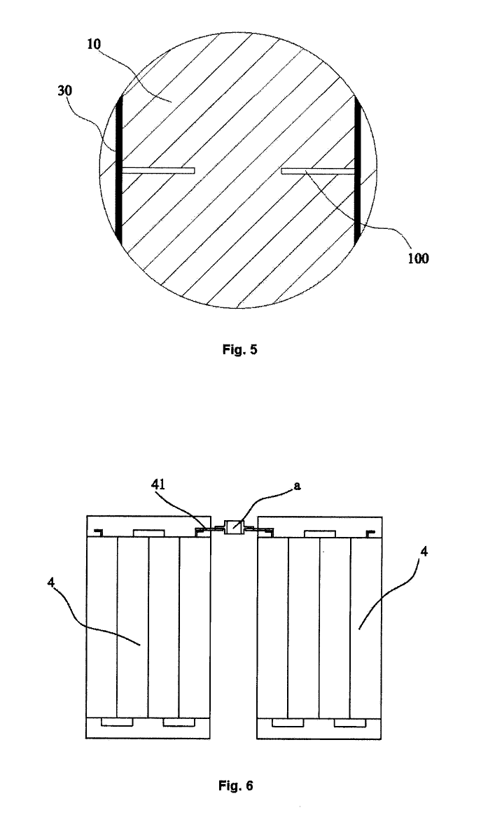

According to an embodiment of the present disclosure, a battery assembly comprising a plurality of batteries electrically connected in series, parallel or in series and parallel with the fusing device as described hereinabove is shown in FIG. 6.

As shown in FIG. 6, the first or second terminal 11, 12 may have through holes 111, 112 for connecting batteries. The batteries 4 may have terminals 41; the fusing device may be connected between the terminals 41; and the connection between the terminals 41 may be formed by any suitable method, such as welding, threaded connection, or plug-switch.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure may be made without departing from the scope or spirit of the present disclosure. Therefore, it is to be understood that the invention is not to be limited to the specific embodiments disclosed and that modifications and other embodiments are intended to be included within the scope of the appended claims.

What is claimed is:

1. A fusing device comprising:
a core portion formed with a first flange at an end thereof and a second flange at the other end thereof;
a first terminal electrically connected with the end of the core portion where the first flange is formed;
a second terminal electrically connected with the other end of the core portion where the second flange is formed; and
at least a thermal expanding element provided between the first flange and the second flange with two ends thereof against the first and second flanges respectively, which is configured to break the core portion during thermal expanding.

2. The fusing device of claim 1, wherein the thermal expanding element is made from a thermal expansion material which is restorable in shape after a transition temperature thereof is reached.

3. The fusing device of claim 1, wherein there are two thermal expanding elements which have a semi-cylindrical shape that fitted over the core body.

4. The fusing device of claim 2, wherein the thermal expansion material is one selected from a group consisting of Cu base shape-memory alloy, Fe base shape-memory alloy, Ni base shape-memory alloy, and shape-memory ceramics.

5. The fusing device of claim 2, wherein the thermal expansion material has an expansion ratio of about 8% to about 10%.

6. The fusing device of claim 1, wherein the core portion is made from material selected from a group consisting of silver, copper, copper alloy, aluminum, or aluminum alloy.

7. The connection release device of claim 1, wherein, the core portion has a rectangular or circular cross section.

8. The fusing device of claim 1, wherein the core portion is formed with at least a notch.

9. The fusing device of claim 7, wherein the notch is formed along a cross section in the middle portion of the core portion with a depth of 1.5 mm to about 3 mm into the core portion and a height of about 0.1 mm to about 0.5 mm along a height of the core portion.

10. The fusing device of claim 1, wherein the first and the second terminals are formed with a through hole respectively.

11. The fusing device of claim 1, further comprising:
a first insulating member provided between the core portion and the thermal expanding element, which is electrically insulated and thermally conductive, and
a pair of second insulating members provided between both ends of the thermal expanding element and the first and second flanges respectively.

12. The fusing device of claim 10, wherein the first insulating member is an insulating layer formed on the core portion, or an injected portion formed on the core portion.

13. The fusing device of claim 10, wherein the second insulating member is formed of a pair of semi-circular insulating rings or is an insulating layer formed on a surface facing the thermal expanding element.

14. The fusing device of claim 11, wherein the insulating layer has a thickness of about 0.05 mm to about 0.2 mm.

15. The fusing device of claim 12, wherein the insulating layer has a thickness of about 0.05 mm to about 0.2 mm.

16. A battery assembly comprising a plurality of batteries electrically connected in series, parallel or in series and parallel with the fusing device of claim 1.

17. A fusing device comprising:
a core portion having a first section and a second section; and
a thermal expanding element connected to the first and second sections of the core portion, wherein the core portion and thermal expanding element are arranged such that an electric current passing through the core portion heats the thermal expanding element and causes the thermal expanding element to expand thermally, and wherein the thermal expansion of the thermal expanding element breaks the core portion when the temperature of the thermal expanding element exceeds a certain value.

18. The fusing device of claim 17, wherein the thermal expanding element is indirectly connected to at least one of the first and second sections of the core portion.

19. A fusing device comprising:
a core portion having a first section and a second section; and
a thermal expanding element connected to the first and second sections of the core portion, wherein the core portion and thermal expanding element are arranged such that an electric current passing through the core portion heats the thermal expanding element and causes the thermal expanding element to expand thermally, and wherein the thermal expansion of the thermal expanding element breaks the core portion when the current in the core portion exceeds a certain value.

20. The fusing device of claim 19, wherein the thermal expanding element is indirectly connected to at least one of the first and second sections of the core portion.
